(19) United States
(12) Patent Application Publication
(10) Pub. No.: US 2013/0240566 A1
(43) Pub. Date: Sep. 19, 2013

(54) PORTABLE, DISPOSABLE, DISPENSER FOR WAXING

(71) Applicant: Tamara Randolph-Colon, Murrieta, CA (US)

(72) Inventor: Tamara Randolph-Colon, Murrieta, CA (US)

(21) Appl. No.: 13/421,446

(22) Filed: Mar. 15, 2012

(51) Int. Cl. B67D 7/80; B65D 37/00

(52) U.S. Cl. 222/146.5; 401/266; 222/215

(57) ABSTRACT

A waxing dispenser has a nozzle with a plurality of channels for delivering hot wax to a nozzle surface placed into contact with the skin. By pressing on the dispenser as its surface is moved over the skin a uniform layer of hot wax is laid down. The nozzle may be easily replaced with one of a different size or shape and the product may be acquired with a selection of the nozzles. The dispenser is designed to be sold at a low price so that it may be considered a one-use item to be disposed of after one or two uses.

No federally sponsored research or development and no sequence listing, table or computer program listing or compact disc appendix is included in this application.

### BACKGROUND

This disclosure relates to the field of cosmetics and more particularly to the removal of exterior body hair especially by waxing (epilation), and specifically to devices for applying strip wax to body and facial surface areas. Strip wax may be a mixture of natural beeswax and tall oil or a synthetic wax. Waxing is a method of semi-permanent hair removal which removes the hair along with its root. New hair generally does not grow back in the previously waxed area for two to eight weeks, although some people experience regrowth in a shorter period. Almost any area of the body can be waxed, including eyebrows, face, bikini area, legs, arms, back, abdomen and feet. There are various techniques of waxing suitable for removing unwanted hair. Strip waxing is accomplished by spreading a special strip wax thinly over the skin. A cloth or paper strip is then pressed on the top of the wax and ripped off with a quick movement against the direction of hair growth. This removes the wax along with the hair that has been captured. Hard waxing is another approach where wax is applied somewhat thickly and with no cloth or paper strips. The wax then hardens as it cools, allowing easier removal by a therapist without the aid of cloths. This waxing method is beneficial to people who have sensitive skin.

The prior art discloses disposable containers for holding wax which may be heated by microwave or hot water and then applied to hairs by manual squeezing of a dispenser. Also disclosed is a depilatory wax heater capable of heating tubes of wax and a gun-like dispenser that heats and dispenses wax from the tubes. Further disclosed is a powered heating unit for one-use cartridges of wax. Also, various sizes and shapes of dispensing orifices are proposed in the prior art. Disclosed is a pen-sized dispenser with mechanized or manual pressurizer and an internal heater, or heating by the application of external microwave energy. Disclosed is a dispenser with a stored amount of material and a bellows type manual pressurizer. Further disclosed is a portable, hand-held, wax dispenser with heating element providing manual dispensing. Disclosed is a multi-use AC powered dispenser. Finally, a pen-sized dispenser with battery operated motorized feeder is disclosed in the prior art. What is not disclosed within the prior art and is needed is a portable strip wax dispenser of that has commercial appeal due to an extremely low manufacturing cost so as to enable one-use dispensing and then disposal. Such a product may be carried by a person in a purse, for instance, and used both at home and “on the road.” Also, not disclosed in the prior art, but clearly needed, is an improved way for dispensing strip wax as a uniformly thin layer at a uniform temperature across its surface where the wax layer is able to be applied more quickly and uniformly thereby allowing a lower temperature of the wax at point of contact and quicker solidification. The present apparatus overcomes these problems and provides these benefits as described below.

### BRIEF SUMMARY AND OBJECTIVES

As described above, it is well known in cosmetology to use hot wax procedures to remove facial and body hair. The hot wax method has the advantage of removing hair roots so that hairs do not reappear quickly as with shaving, depilatory creams, and other methods of hair removal. The presently described apparatus provides a low temperature melting point strip wax held within a squeeze tube having a novel dispensing nozzle with a wide landing zone for the beneficial ejection of liquid wax onto a skin surface. The hot wax hair removal method requires delivery of molten wax to a selected skin surface, capture of a cloth strip within the dispensed wax as it solidifies, and then ripping the wax away from the skin using the cloth. Any facial or body hairs that are captured within the solidified wax are pulled away by their roots so that hair and root structures are removed at the same time.

One aspect of the presently described apparatus is the ability to soften and melt strip wax within the apparatus by using hot water or other heat source.

Another aspect is that a continuous flow of molten wax is able to be delivered by hand squeezing of the apparatus.

Another aspect is a dispensing surface having a length equal to the width of as a desired wax line.

Another aspect is that the wax is able to be dispensed onto a nozzle contact surface as a uniformly thin layer which is then able to be delivered to the skin surface quickly and uniformly.

Another aspect is that as the wax flows onto the nozzle's dispensing surface it is immediately delivered to the contacting skin surface without needing to be moved around and spread-out by the nozzle tip thereby saving time and requiring no application finesse or technique.

Another aspect is that since the time required to thin and spread-out dispensed wax is eliminated, the wax may be delivered at a lower initial temperature to the skin surface so as to lessen the discomfort of hot wax on the skin.

Another aspect is that the apparatus is able to be manufactured and sold at such a low cost that it may be used once or just several times and then disposed of.

Another aspect is that the wax is able to be melted under a hot water faucet.

Another aspect is that the wax is able to be melted within a standard microwave oven without fear of the cartridge exploding.

The details of one or more embodiments of these concepts are set forth in the accompanying drawings and the description below. Other features, objects, and advantages of these concepts will be apparent from the description and drawings, and from the claims.

### BRIEF DESCRIPTION OF THE SEVERAL VIEWS OF THE DRAWING

FIG. 1 is an example perspective view of the presently described apparatus;

FIG. 2 is an example vertical sectional view thereof as taken along section line 2-2 in FIG. 1;

FIG. 3 is an example side elevational view thereof further including a cap;

FIG. 4 is a partial view taken from FIG. 3 at cutaway 4;

FIG. 5 is an example side elevational view thereof showing a nozzle with a dispensing surface at an oblique angle;

FIGS. 6A, 7A, 8A, and 9A are example front elevational views of various alternative embodiments of the apparatus; and

FIGS. 6B, 7B, 8B, and 9B are corresponding respective top plan views of the alternative embodiments.

Like reference symbols in the various drawings indicate like elements.

### DETAILED DESCRIPTION

Moldable wax compositions, such a described in patent U.S. Pat. No. 3,600,202, which melt at temperatures in the range of about 125-140 degrees F. or even lower, may be used in the apparatus herein described for enabling a novel strip waxing method; both the apparatus and its novel use described herein.

In one embodiment of the presently described hot wax dispensing apparatus 10 (FIG. 1), a flexible tubular body 20 has a nozzle 30 at a first end 22 of body 20, and a seal 40 at a second opposing end 24 of body 20. A quantity of depilatory strip wax 50 is contained within the body 20 and is normally in a solidified form at room temperature. Low melting point waxing products are in the commercial market and exemplified by the products sold by Epillyss Products of Bolingbrook, Ill. who carry an extensive line of low melting point waxes (in the range of from 95-110 degrees F.), plus rolls and strips of waxing fabrics made of paper, cotton, muslin and other materials.

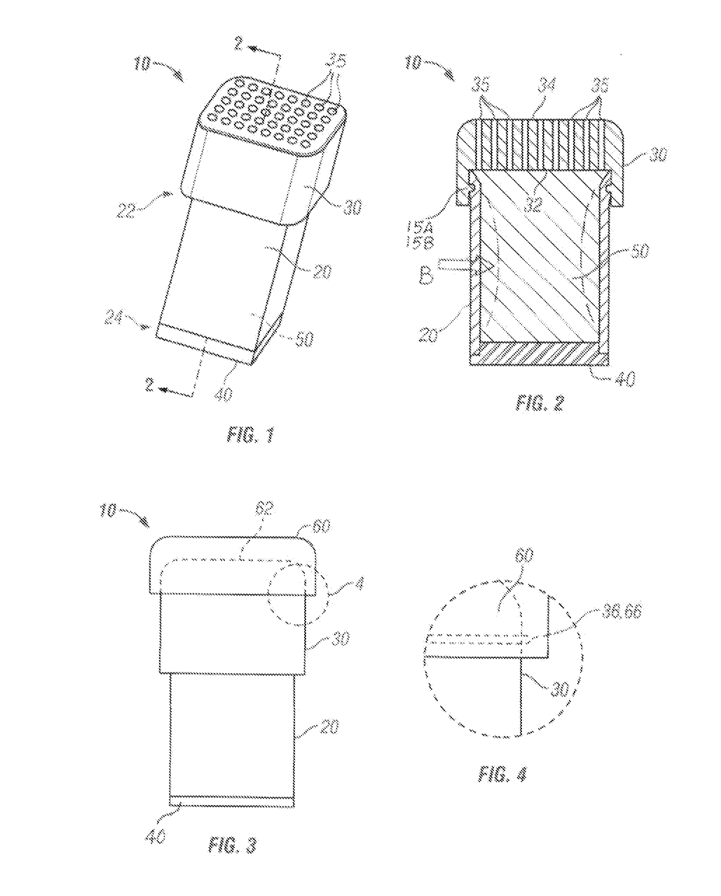

As shown in FIG. 2, the nozzle 30 has an interior nozzle surface 32 within the body 20 and an exterior nozzle surface 34 exterior to body 20. The nozzle 30 has a plurality of open channels 35 which extend between the interior surface 32 and the exterior surface 34 of the nozzle 30. As shown in FIG. 3, a removable cap 60 is secured over the nozzle 30, wherein an interior cap surface 62 is in contact with the exterior nozzle surface 34. As shown in FIG. 4, the nozzle 30 and the cap 60 have mutually engaging elements 36 and 66 respectively, which secure the cap 60 over the nozzle 30 yet may be easily disengaged for manual removal of the cap 60. The elements 36 and 66 may be an annular bead and a corresponding annular indentation respectively. This securement prevents the flow of wax 50 when it is not desired. The nozzle 30 may be made of a thermally insulating material such as a microcell polystyrene foam or similar material.

Each one of the channels 35 within nozzle 30 may be less than 0.032 inches in diameter and the diameter of each one of the channels 35 may have uniformly narrowing diameters so that at the exterior nozzle surface 34 the diameters of each channel 35 may be at least 10% smaller than at the interior nozzle surface 32. The many channels allow dispensing of hot wax uniformly over surface 34 so that when surface 34 is placed into contact with the skin surface, surface 34 may be moved directly along an intended line rather than having to spread a blob of dispensed wax which typically results in a messy and uneven wax coating which may be thermally non-uniform thereby resulting in non-uniform hair removal. With narrowing channels 35, the liquid wax is dispensed in an energetic manner which tends to improve the uniformity of the entire wax mass over surface 34. In other words the wax does not just simply emerge and pool around the exit openings of the channels 35, rather it squirts slightly so as to cover a larger surface area and more quickly with significant mixing between the wax dispensed simultaneously from the several separate channels 35.

The channels may be spaced apart by not more than 0.032 inches at the exterior nozzle surface 34. This surface 34 may be planar and may have a rectangular, oval, or round shape as these shapes have been found to provide improved wax distribution on the area of skin that one wishes to cover. To cover a larger surface area exterior nozzle surface 34 may be positioned at an oblique angle “A” of between 40 and 50 angular degrees relative to a longitudinal axis 5 of body 20, as shown in FIG. 5. In FIGS. 5, 6B, 7B, 8B, and 9B the dashed lines hypothetically represent the paths of channels 35.

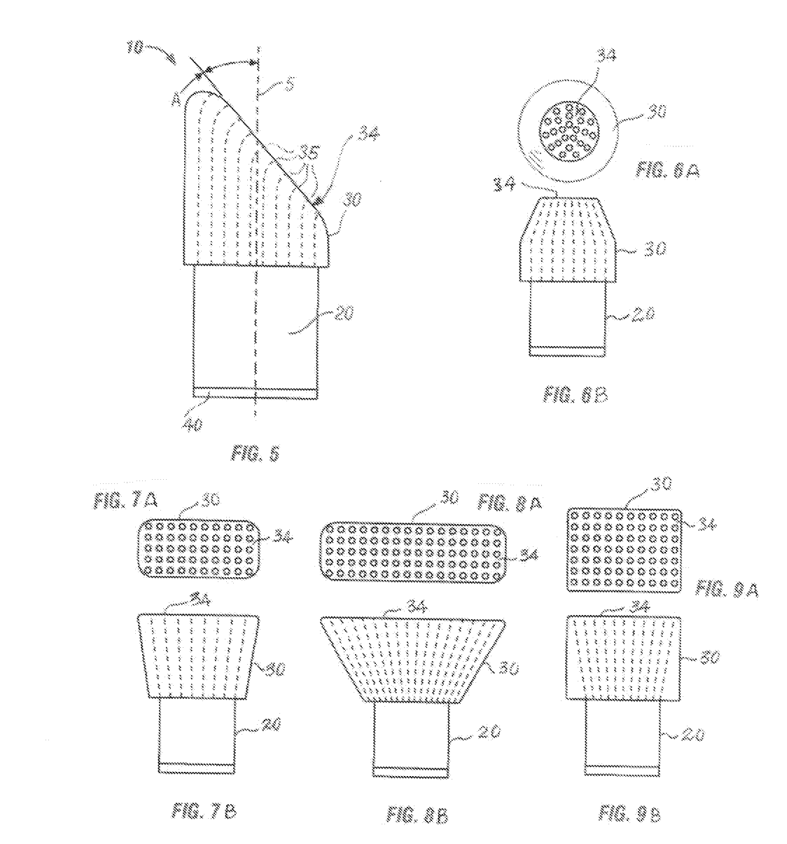

Nozzle 30 may be formed integrally with tubular body 20 as is known with the majority of commercial products that are integrally molded by vacuum forming or injection molding. In some prior art, bodies are filled with product at an open end opposing a nozzle and then sealed at that open end. Product is dispensed by squeezing the body after uncapping. Alternately, as shown in FIG. 2, the present apparatus may provide a non-integral nozzle 30, but rather one that is mechanically secured so that it can be easily replaced interchangeably with alternately shaped nozzles 30. Such securement may take the form of a first mechanical element such as an annular groove 15A on either the nozzle 30 or the body 20, and a mating second mechanical element such as an annular rib 15B on the alternate part as shown in FIG. 2. Other means for removable attachment may be used. Alternate nozzles may have sizes and shapes as shown in FIGS. 5, 6A/B, 7A/B, 8A/B, and 9A/B so that they can lay-down a wax path of various widths or for dabbing various shapes of dispensate on a selected hairy area of a human or animal body. In the present apparatus, wax is dispensed by pressing on opposing sides of body 20 as indicated by dashed lines and by arrow B in FIG. 2.

The paper or cloth strips which are used in the strip waxing method are not described here since these items are well known in the art, commercially available and references above. The above described apparatus with wax 50 inside may be heated under a hot water tap which typically dispenses water at about 125-130 degrees F. which may be considerably higher than the melting point of wax 50. Once the wax within the body 20 has melted, the body may be placed within an insulating sheath (not shown) as for instance of polystyrene which may be sold with the apparatus or separately. This insulating sheath enables the wax 50 to maintain its heat allowing the dispensing of hot wax for a longer time than would be otherwise possible. It also allows holding the apparatus 10 when it is hot without discomfort. As the hot wax flows through the nozzle 30 it tends to loose little of its heat because of the thermal insulating property of which the nozzle 30 is made. Once on the skin surface, the wax 50 starts to cool and after a few seconds solidifies. Prior to the wax hardening, a paper or cloth waxing strip (which may be sold with the apparatus) is placed into contact with the liquid hot wax 50 and is therefore captured within the solid wax 50. Finally, the strip is quickly yanked away in a shearing motion whereby the wax is removed along with embedded hairs. If sufficiently hot tap water is not available, a tea pot or similar article may be used to heat water to above the melting temperature of the wax 50. The apparatus 10 with its cap 60 in place may be set into the hot water for about 20-30 seconds to assure thorough wax liquidity and then used as described. Alternatively, the apparatus 10 may be placed into a microwave oven for about 30-45 seconds to accomplish the same result.

The tubular body 20 may be a flexible plastic tube similar to a toothpaste tube. Alternately, the body 20 and the nozzle may be injection molded. When heated the body 20, being highly flexible, is able to bulge outwardly to prevent splitting when heated within a microwave oven or otherwise. The wax 50 may be placed into body 20 as a solid block or in the liquid state. In the latter case, the wax 50 may be placed into the body 20 through its open top and then the nozzle may be snapped over the open top as best shown in FIG. 2. The body 20, nozzle 30 and cap 60 may be injection molded within a common multi-cavity tooling with an estimated total cost of resin and labor of about ten cents when manufactured in quantity. The wax 50 will cost about two cents per shot, again when used in quantity. Molding and wax fill may be automated so that the total manufacturing cost of the finished product may be less than about twelve cents. Amortized tooling, packaging, shipping and advertising, etc. will add about fifteen cents per unit. Therefore, the unit cost may be as low as twenty-seven cents per unit. The consumer unit sales price can be as low as about $1.99 with a gross margin of at least several times cost. It is estimated that at the latter selling price, the consumer will have no difficulty in using the apparatus even just once or just a few times and then replacing it with a new one.

Embodiments of the subject apparatus and method have been described herein. Nevertheless, it will be understood that various modifications may be made without departing from the spirit and understanding of this disclosure. Accordingly, other embodiments and approaches are within the scope of the following claims.

What is claimed is:

1. A hot wax dispensing apparatus comprising:
a tubular body engaged with a nozzle at a first end of the body, and closed at a second opposing end of the body;
an interior space of the body for receiving a quantity of depilatory solid wax within;
the nozzle having a planar exterior surface and a plurality of at least ten channels extending between the interior space of the body and the planar exterior surface, the channels defining openings at the planar exterior surface; and
a removable cap secured over the nozzle, an interior surface of the cap in contact with the planar exterior surface of the nozzle.

2. The apparatus of claim 1 wherein the cap and nozzle have mutually engaging elements securing the cap to the nozzle so that the cap is selectively removable and replaceable.

3. The apparatus of claim 1 wherein the nozzle is made of a thermally insulating material.

4. The apparatus of claim 1 wherein each one of the channels is less than 0.040 inches in diameter.

5. The apparatus of claim 1 wherein the openings of the channels at the planar exterior surface of the nozzle are smaller than an average diameter of the channels.

6. The apparatus of claim 1 wherein the channels are spaced apart by not more than 0.040 inches at the exterior surface of the nozzle.

7. The apparatus of claim 1 wherein the exterior surface of the nozzle is one of rectangular, oval and round shaped.

8. The apparatus of claim 1 wherein the exterior surface of the nozzle is positioned at an oblique angle relative to a longitudinal axis of the tube.

9. The apparatus of claim 1 wherein the nozzle is integrally formed with the body.

10. The apparatus of claim 1 wherein the nozzle is removably engaged with the body by interlocking elements.

11. A hot wax dispensing apparatus comprising:
a tubular body having a nozzle engagement element at a first end of the body and a closed second opposing end of the body;
a quantity of depilatory solid wax within an interior space within the body;
a plurality of nozzles each engagable with the nozzle engagement element at the first end of the body;
each of the nozzles having a plurality of at least 10 channels there through, the channels open to an exterior planar surface of the nozzle, thereby defining openings thereon; and
a plurality of removable caps, each removably securable on one of the nozzles for stemming wax flow therefrom.

12. The apparatus of claim 11 wherein each said cap and corresponding nozzle have mutual securement elements for holding the cap to the nozzle.

13. The apparatus of claim 11 wherein the nozzles are made of a thermally insulating material.

14. The apparatus of claim 11 wherein each one of the channels is less than 0.040 inches in diameter.

15. The apparatus of claim 11 wherein the channel openings are each smaller in size than an average size of each respective channel.

16. The apparatus of claim 11 wherein the channels of each one of the nozzles are spaced apart by not more than 0.040 inches at the exterior surface.

17. The apparatus of claim 11 wherein the exterior surface of each one of the nozzles is one of rectangular, oval and round shaped.

18. The apparatus of claim 11 wherein the exterior surface of at least one of the nozzles is positioned at an oblique angle relative to a longitudinal axis of the tube.
